(19) United States
(12) Patent Application Publication
(10) Pub. No.: US 2005/0083283 A1
(43) Pub. Date: Apr. 21, 2005

(54) Differentiating circuit display

(75) Inventor: Willem den Boer, Hillsboro, OR (US)

Correspondence Address: KOLISCH HARTWELL, P.C., 520 S.W. YAMHILL STREET, SUITE 200, PORTLAND, OR, 97204, US

(73) Assignee: ScanVue Technologies LLC

(21) Appl. No.: 10/966,211

(22) Filed: Oct. 15, 2004

Related U.S. Application Data
(60) Provisional application No. 60/512,032, filed on Oct. 17, 2003.
(60) Provisional application No. 60/527,128, filed on Dec. 5, 2003.
(60) Provisional application No. 60/560,431, filed on Apr. 7, 2004.

(51) Int. Cl. G09G 3/00; G09G 3/36

(52) U.S. Cl. 345/87

(57) ABSTRACT

A display includes a matrix of pixels arranged in a plurality of pixel rows and at least one select line operatively connected to each pixel row. The display also includes a scan controller configured to select pixel rows by applying a sloped select pulse to a select line operatively connected to that pixel row and/or by applying a select pulse to a select line operatively connected to that pixel row, wherein the scan controller is configured to increase an amplitude of the select pulse over time.

### CROSS-REFERENCES

This application claims the benefit of U.S. Provisional Application No. 60/512,032, filed Oct. 17, 2003, No. 60/527,128 filed Dec. 5, 2003, and No. 60/560,431, filed Apr. 7, 2004, each of which is incorporated by reference.

### BACKGROUND

Many devices now include displays for presenting visual information. In general, a display has several attributes that affect its suitability for a particular purpose. Among these attributes are size, brightness, resolution, clarity, and energy consumption. Display sizes-can range from between less than an inch to a few inches diagonal viewing area for handheld devices, such as cellular telephones and portable televisions, to between tens or hundreds of feet for stadium displays. Depending on the desired viewing area for a particular display application, various technologies may be more suitable than others.

### BRIEF DESCRIPTION OF THE DRAWINGS

FIG. 1 shows an exemplary differentiating circuit.

FIG. 2 shows an embodiment of the differentiating circuit of FIG. 1.

FIG. 3 shows exemplary select pulses.

FIG. 4 shows exemplary sloped select pulses.

FIG. 5 shows exemplary select pulses that increase amplitude over time to compensate for aging effects.

FIG. 6 shows exemplary sloped select pulses that increase amplitude over time to compensate for aging effects.

### DETAILED DESCRIPTION

Active matrix liquid crystal displays are widely used in a variety of applications, including notebook computers, flat panel monitors, handheld computers, cellular phones, and flat panel televisions. Active matrix liquid crystal displays may be fabricated by depositing and patterning various metals, insulators, and semiconductors on substrates. Such displays commonly employ semiconductor devices, such as amorphous silicon (a-Si) thin film transistors. Each pixel in the active matrix liquid crystal display may be coupled to an address transistor, which controls the voltage on each pixel and therefore its transmittance.

A growing application for active matrix liquid crystal displays is in large area televisions, which may have a diagonal size of up to 50 inches or more. However, thin film transistor controlled pixel arrays are difficult to manufacture for this application since a relatively large number of process steps are required to construct the thin film transistors. The total mask count may be 5 or 6 or more, which is burdensome. While the yields for small displays can be quite high, it is difficult to obtain an acceptable yield for large area displays. In addition, the design rules for patterning the various insulator, metal, and semiconductor layers are the same for small and large thin film transistor liquid crystal displays, requiring expensive photo-exposure equipment for large area substrates. This all increases the manufacturing expense of such thin film transistor liquid crystal displays.

Nonlinear resistors can be used in place of transistors in a display circuit. A nonlimiting example of a nonlinear resistor is a thin film diode. Thin film diodes, including those referred to as metal-insulator-metal diodes, can be more economical to fabricate than a-Si thin film transistors. When a single thin film diode is used in series with a liquid crystal pixel, any variation in the thin film diode characteristic across the display area or over time or temperature can lead to a variation in the pixel voltage. This can result in poor gray scale control, poor uniformity, slow response time, and/or image sticking. In addition, it is difficult, if not impossible, to scale up single thin film diode liquid crystal displays to a diagonal size larger than about 10 inches without severe brightness gradients.

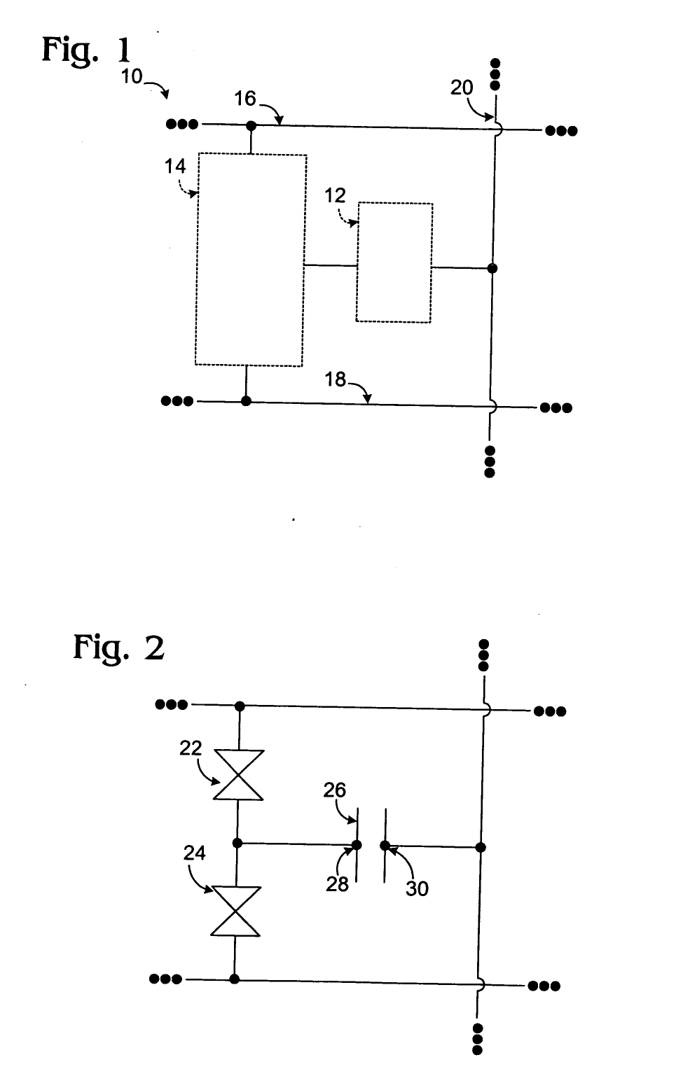

However, a differential circuit may mitigate, if not eliminate, the drawbacks of the single thin film diode approach. FIG. 1 shows an exemplary differential circuit 10, which includes a light-producing module 12 and a differentiating module 14. The circuit also includes select line 16 and select line 18, which are operatively connected to different nodes of differentiating module 14. The circuit also includes a data line 20 that is operatively connected to the light-producing module. As shown in FIG. 2, a differentiating module can include a pair of nonlinear resistors, such as bidirectional diode 22 and bidirectional diode 24. The light producing module can include a capacitor 26 having a pixel node 28 that is operatively connected to different select lines by way of a differentiating module. The capacitor also may include a data node 30 that is operatively connected to a data line. The light producing module may include an exit polarizer configured to modulate light output responsive to the relative charge of the capacitor. U.S. Pat. Nos. 4,731,610, 6,222,596, 6,225,968, and 6,243,062 describe exemplary arrangements that utilize a differential circuit, and are hereby incorporated herein by reference. Such displays are herein referred to as dual select diode displays.

The fabrication of a dual select diode matrix array for active matrix liquid crystal displays can be achieved in only two or three mask steps, with relaxed design rules that scale with the display size. When operated in a dual select mode, the pixel circuit can act as an analog switch. The dual select diode circuit is not a two-terminal switching device, but rather a three-terminal switching device similar to a circuit utilizing thin film transistors. A dual select diode circuit can perform comparably to a thin film transistor liquid crystal display as a result of accurate gray scale control, fast response time, and tolerance for variations in thin film diode characteristics over time and across the viewing area. Such a dual select diode liquid crystal display also can be relatively insensitive to RC delays on the select and data lines and can therefore be scaled up to very large area, for example, exceeding 40 inches in diagonal size.

One example of a nonlinear resistor suitable for use in a differentiating module is an SiNx thin film diode, which includes a silicon-rich silicon nitride layer sandwiched between opposing electrodes, such as a transparent electrode (e.g. ITO) and a metal electrode. Although the switching characteristics of SiNx diodes are suitable for use in active matrix liquid crystal displays, they can experience an aging phenomenon over time, i.e. their ON current at a fixed voltage can decrease. Although a dual select diode circuit can limit the effects of aging, such aging may eventually lead to brightness gradients along the direction of the select lines in the display, burn-in of fixed images, and/or other undesirable side effects. Such aging phenomenon can lessen display quality throughout a display's lifetime, which can be at least 30,000 hours to 60,000 hours in television or monitor applications.

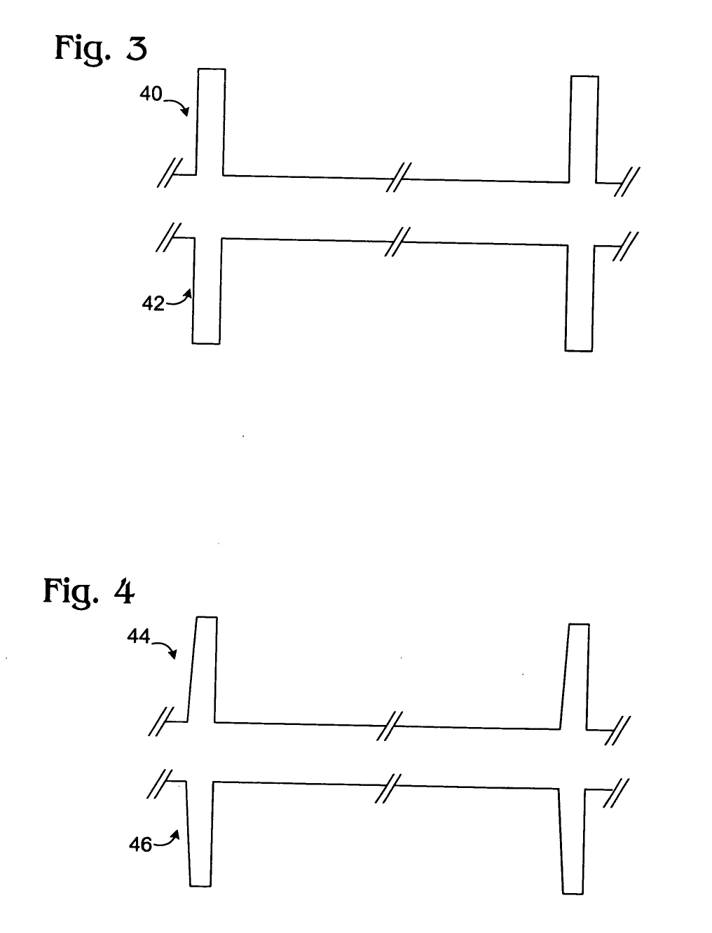

A row of pixels can be selected by applying opposite polarity select signals to the select lines associated with that row of pixels. A display can include a scan controller for applying such select signals to the various select rows of a display when a row associated with those select lines is to be selected. Corresponding data signals can be applied by a data controller to data lines, which can take the form of ITO stripes functioning as counter-electrodes of liquid crystal pixels on the color plate. A nonlimiting example of a suitable scan controller includes one or more row driver integrated circuits; and a nonlimiting example of a data controller includes one or more column driver integrated circuits. In some embodiments, scanning and loading data may be performed by the same controller. The dual select diode active matrix liquid crystal display can output an image corresponding to the video signals applied to the data lines. FIG. 3 schematically shows exemplary opposite polarity select pulses 40 and 42, which can be used to select a row of pixels. It should be understood that each row may be sequentially selected for only a line time, which is a fraction of a frame time. As a nonlimiting example, in a display with 1000 rows, each row could be selected for only 0.1% of the time.

The aging phenomena in thin film diodes, or other nonlinear resistors, may be accelerated when a peak current flows instantaneously through the diode, significantly exceeding the steady-state current in the pixel circuit. In order to eliminate or reduce the peak current, and therefore the aging, each select line may be addressed with a specially configured select pulse, such as a sloped select pulse. For example, a select pulse characterized by a rise time between approximately 0.2 μsec to 4.0 μsec may suppress the peak current. FIG. 4 schematically shows exemplary sloped pulses 44 and 46, which can be used to select a row of pixels while limiting aging effects.

A reduction in the peak current can slow decreases to the ON current of a thin film diode over time, thus increasing display effectiveness over a longer period of time. In some embodiments, the select pulse may be increased to its final value in discrete steps. In some embodiments, the select pulse may be sloped according to a continuous, piecewise continuous, or noncontinuous function. The duration over which the select pulse is increased and the function of the slope may be selected to minimize aging affects of a particular display circuit. The examples provided herein are not limiting.

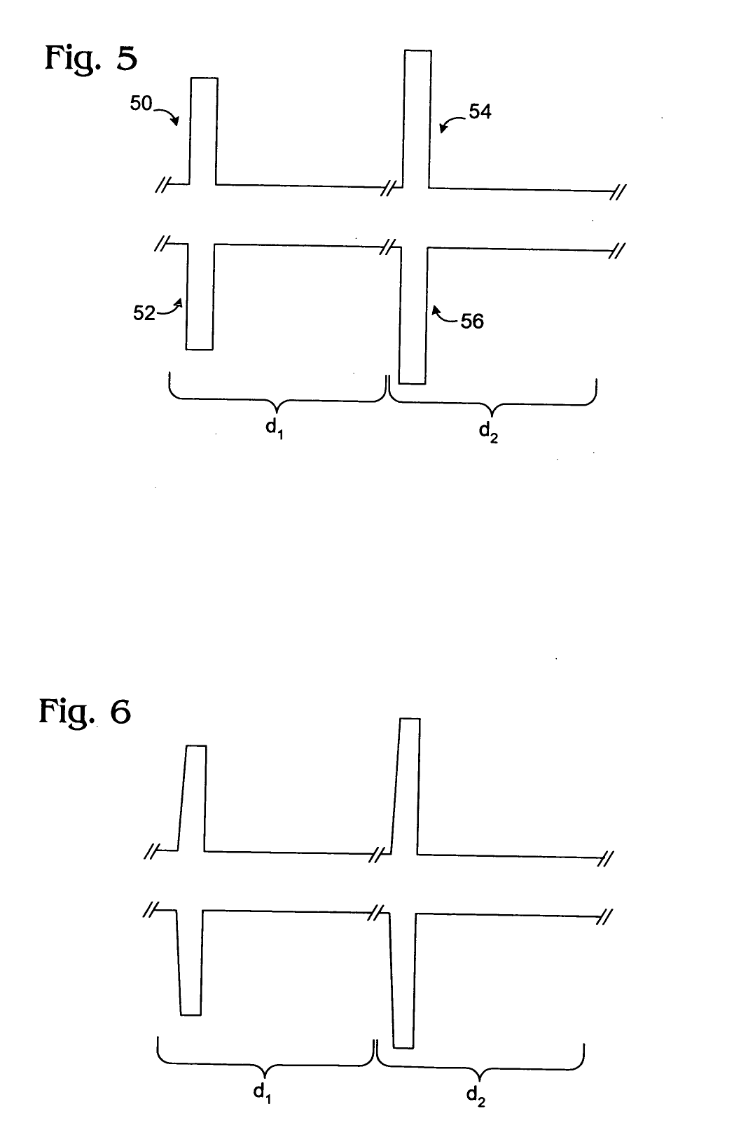

In some embodiments, a select line may be addressed by select pulses with amplitudes that are configured to compensate for aging during the operating lifetime of the display. For example, in some embodiments, the voltage of a select pulse may be increased over the course of a display's lifetime to compensate for the aging phenomenon described above. FIG. 5 schematically shows exemplary select pulses 50 and 52, which can be applied during a first duration of operation d₁, and exemplary select pulses 54 and 56, which can be applied during a second duration of operation d₂. As can be seen, select pulses 54 and 56 have greater amplitudes than select pulses 50 and 52.

Increasing the voltage over time can keep the ON current substantially sufficient to charge the pixels to the desired gray level throughout the lifetime of the display. In other words, the increase in the select pulse amplitudes can compensate for the reduction in the ON current of the diode over time. Such an increase in voltage may be used in addition to or alternative of select pulse sloping. FIG. 6 schematically shows exemplary sloped select pulses 60 and 62, which can be applied during a first duration of operation d₁, and exemplary select pulses 64 and 66, which can be applied during a second duration of operation d₂. The sloped select pulses applied during the second duration of operation have greater amplitudes than the sloped pulses applied during the first duration of operation. Drive methods that utilize sloped or stepped select pulses and/or select pulse configurations that are altered over time to compensate for aging can maintain the image quality of a dual select diode active matrix liquid crystal display over its lifetime.

Characteristics of a select pulse other than voltage amplitude may additionally or alternatively be changed over time to compensate for the aging phenomenon. For example, the function of a select pulse may be changed over time, becoming steeper, less steep, or having a different shape.

The configuration of a select pulse can be changed over time according to a predetermined schedule, such as a schedule that corresponds to the operating time of a display. For example, display behavior may be tested and/or predicted, and a select pulse schedule may be created to, change the character of the select pulse to compensate for and/or limit aging phenomenon based on the tested and/or predicted display behavior. In some embodiments, the configuration of a select pulse may be adjusted based on real-time measured display performance. In other words, changes may be based on measurements taken throughout the life of a display. The configuration of a select pulse may be changed one or more times throughout the course of a display's life. For example, in some embodiments, pulse amplitude may be increased by a predetermined amount upon reaching a triggering event, such as 1,000 hours of operation, 5,000 hours of operation, 10,000 hours of operation, etc. In such cases, the increase in the pulse amplitude can be the same at each triggering event, or a change at a triggering event can be different than a change at another triggering event. The duration between such milestones may also be uniform or different. Similarly, the duration may be selected to be virtually any length in order to effectively compensate for aging.

Although described in the context of dual select diode liquid crystal display arrangements, the above described compensation and prevention mechanisms can be applicable to any arrangement that is susceptible to similar aging phenomenon. Accordingly, the correction methods described herein can be applied to such arrangements to improve performance throughout a device's lifetime.

Although the present disclosure has been provided with reference to the foregoing operational principles and embodiments, it will be apparent to those skilled in the art that various changes in form and detail may be made without departing from the spirit and scope defined in the appended claims. The present disclosure is intended to embrace all such alternatives, modifications and variances. Where the disclosure or claims recite “a,” “a first,” or “another” element, or the equivalent thereof, they should be interpreted to include one or more such elements, neither requiring nor excluding two or more such elements.

1. A display comprising:
a matrix of pixels arranged in a plurality of pixel rows;
at least one select line operatively connected to each pixel row; and
a scan controller configured to select a pixel row by applying a sloped select pulse to a select line operatively connected to that pixel row.

2. The display of claim 1, wherein the sloped select pulse has a rise time of greater than approximately 2×10⁻⁶ seconds.

3. The display of claim 1, wherein the sloped select pulse has a rise time between approximately 2×10⁻⁶ seconds and 5×10⁻⁵ seconds.

4. The display of claim 1, wherein the scan controller is configured to increase an amplitude of the select pulse over time.

5. The display of claim 1, wherein each pixel includes a dual select diode circuit.

6. The display of claim 5, wherein each dual select diode circuit includes:
a capacitor having a pixel node and a data node;
a first nonlinear resistor operatively connected to the pixel node of the capacitor; and
a second nonlinear resistor operatively connected to the pixel node of the capacitor;
wherein each of the first and second nonlinear resistors is operatively connected to a different select line.

7. The display of claim 6, wherein the capacitor is a constituent element of a light-producing module, and wherein the capacitor is configured to control characteristics of light output via the light-producing module.

8. The display of claim 7, wherein the light-producing module includes an exit polarizer configured to modulate light output responsive to a relative charge of the capacitor.

9. The display of claim 6, wherein each of the first nonlinear resistor and the second nonlinear resistor includes a bidirectional diode.

10. A display comprising:
a matrix of pixels arranged in a plurality of pixel rows;
at least one select line operatively connected to each pixel row; and
a scan controller configured to select pixel rows by applying a select pulse to a select line operatively connected to that pixel row, wherein the scan controller is configured to increase an amplitude of the select pulse over time.

11. The display of claim 10, wherein the scan controller is configured to increase the amplitude of the select pulse according to a predetermined schedule.

12. The display of claim 10, wherein the scan controller is configured to increase the amplitude of the select pulse after a predetermined duration of operation.

13. The display of claim 10, wherein the scan controller is configured to increase the amplitude of the select pulse responsive to real-time measured display performance.

14. The display of claim 10, wherein each pixel includes a dual select diode circuit.

15. The display of claim 14, wherein each dual select diode circuit includes:
a capacitor having a pixel node and a data node;
a first nonlinear resistor operatively connected to the pixel node of the capacitor; and
a second nonlinear resistor operatively connected to the pixel node of the capacitor;
wherein each of the first and second nonlinear resistors is operatively connected to a different select line.

16. The display of claim 15, further comprising a light-producing module associated with the capacitor, wherein the capacitor is configured to control characteristics of light output via the light-producing module.

17. The display of claim 16, wherein the first light-producing module includes an exit polarizer configured to modulate light output responsive to the relative charge of the capacitor.

18. The display of claim 15, wherein each of the first nonlinear resistor and the second nonlinear resistor includes a bidirectional diode.

19. The display of claim 10, wherein the scan controller is configured to apply a sloped select pulse.

20. The display of claim 19, wherein the sloped select pulse has a rise time of greater than 2×10⁻⁶ seconds.

21. The display of claim 19, wherein the sloped select pulse has a rise time between approximately 2×10⁻⁶ seconds and 5×10⁻⁵ seconds.

22. A method of improving lifetime display performance while selecting a pixel row in a dual select diode display, the method comprising:
applying a sloped select pulse to a select line operatively connected to a first row of pixels, each pixel including a dual select diode circuit.

23. The method of claim 22, wherein the sloped select pulse has a rise time of greater than 2×10⁻⁶ seconds.

24. The method of claim 22, wherein the sloped select pulse has a rise time between approximately 2×10⁻⁶ seconds and 5×10⁻⁵ seconds.

25. A method of improving lifetime display performance while selecting a pixel row in a dual select diode display, the method comprising:
applying a select pulse having a first amplitude during a first duration of operation;
applying a select pulse having a second amplitude, greater than the first amplitude, during a second duration of operation.

26. The method of claim 25, wherein the first duration and the second duration are selected based on a predetermined schedule.

27. The method of claim 25, wherein the first duration and the second duration are selected responsive to real-time measured display performance.

28. The method of claim 25, wherein applying a select pulse includes applying a select pulse to a select line operatively connected to a first row of pixels, each pixel including a dual select diode circuit.
